(19) United States
(12) Patent Application Publication
(10) Pub. No.: US 2024/0408906 A1
(43) Pub. Date: Dec. 12, 2024

(54) TECHNOLOGY FOR CONTROLLING SHAPE OF IMAGE FORMED BY IMAGE FORMING APPARATUS

(71) Applicant: CANON KABUSHIKI KAISHA, Tokyo (JP)

(72) Inventor: EIKOU MORI, Tokyo (JP)

(21) Appl. No.: 18/677,006

(22) Filed: May 29, 2024

(30) Foreign Application Priority Data
Jun. 6, 2023 (JP) 2023-093309

(51) Int. Cl. B41J 29/393; B41J 2/045

(52) U.S. Cl. CPC B41J 29/393; B41J 2/04505; B41J 2/04573; B41J 2029/3935

(57) ABSTRACT

A belt member conveys a sheet while carrying a sheet. An image forming unit is provided with a plurality of nozzles for ejecting inks and forms an image on the sheet carried by the belt member using the ink ejected from the plurality of nozzles. A reader reads the sheet on which the image is formed by the image forming unit. A memory stores data regarding a tilt of the reader. A controller controls the image forming unit to form a test image on a sheet, and determines a misalignment of a first direction in which the plurality of nozzles are arranged with respect to a second direction based on the data stored in the memory and a result of reading the sheet read by the reader and on which the test image is formed.

### BACKGROUND OF THE INVENTION

### Field of the Invention

The present disclosure relates to technology for controlling the shapes of images formed by an image forming apparatus.

### Description of the Related Art

In recent years, electrophotographic methods or inkjet methods are becoming spread even in a commercial printing market where offset printing was a mainstream. In order for electrophotographic or inkjet printers to spread in the commercial printing market, electrophotographic or inkjet methods need to achieve image quality comparable to that of offset printing methods. In particular, squareness of an image formed on a sheet is important. If the squareness of an image is lost, a position of the image formed on a front side of a sheet and a position of the image formed on a back side of the sheet will be misaligned. For example, in a case where the position of the image on the front side is misaligned with the position of the image on the back side, then the quality of the images printed on the left and right pages in a spread page product will deteriorate due to misalignment. The misalignment between the position of the image formed on the front side of the sheet and the position of the image formed on the back side of the sheet is referred to as “front/back misalignment”. In an offset printing machine, prior to printing, a skilled technician performs a printing position adjustment operation including adjustment of image squareness. As a result, the front/back misalignment is suppressed to approximately 0.1 mm to 0.2 mm. However, an issue arises that this adjustment operation is time-consuming and requires a skilled technician.

An inkjet printer ejects ink from a plurality of recording heads onto a sheet conveyed by a printing belt to form an image on the sheet. Thus, misalignment between a printing belt and recording heads reduces the squareness of the image. For example, an image that needs to be rectangular would be a parallelogram. When installing an inkjet printer or replacing a recording head, a skilled person measures the amount of misalignment using a scale and finely and manually adjusts the position of the recording head.

Japanese Patent Laid-Open No. 2015-107656 discloses that the position of a recording head is measured using a position sensor, and the position of the recording head is adjusted to an ideal position. Japanese Patent Laid-Open No. 2020-172084 discloses that an image on the sheet conveyed by a printing belt is read by a scanner in order to adjust relative positions between a plurality of recording heads.

The method disclosed in Japanese Patent Laid-Open No. 2015-107656 requires a position sensor for each recording head. When attempts are made to apply the method disclosed in Japanese Patent Laid-Open No. 2020-172084 to correct the squareness of an image, misalignment between a printing belt and a scanner makes it difficult to measure misalignment between the printing belt and recording heads.

### SUMMARY OF THE INVENTION

The present disclosure provides an image forming apparatus comprising: a belt member configured to convey a sheet while carrying the sheet; an image forming unit provided with a plurality of nozzles for ejecting ink and configured to form an image on the sheet carried by the belt member using the ink ejected from the plurality of nozzles; a reader configured to read the sheet on which the image is formed by the image forming unit; a memory on which data regarding a tilt of the reader is stored; and a controller configured to control the image forming unit to form a test image on a sheet, and determine a misalignment of a first direction in which the plurality of nozzles are arranged with respect to a second direction based on the data stored in the memory and a result of reading the sheet read by the reader and on which the test image is formed.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus.

FIG. 2 is a diagram illustrating a printing module.

FIG. 3 is a diagram illustrating a belt unit.

FIG. 4 is a perspective view illustrating a structure of a recording head.

FIGS. 5A and 5B are diagrams illustrating positioning of the recording heads.

FIGS. 6A to 6C are diagrams illustrating a positioning structure.

FIG. 7 is a diagram illustrating an inline scanner.

FIG. 8 is a diagram illustrating a test image.

FIG. 9 is a diagram illustrating a deterioration of the squareness of an image according to the tilt (misalignment) of the recording head.

FIG. 10 is a diagram illustrating front/back misalignment.

FIG. 11 is a diagram illustrating the tilt of the inline scanner.

FIGS. 12A and 12B are diagrams illustrating the influence of the tilt of the inline scanner.

FIG. 13 is a diagram illustrating a method for acquiring the tilt of the inline scanner.

FIG. 14 is a diagram illustrating a controller.

FIG. 15 is a diagram illustrating a correcting unit.

FIG. 16 is a diagram illustrating a function for acquiring the tilt of the inline scanner.

FIG. 17 is a flowchart showing a method for correcting the squareness of an image.

FIG. 18 is a diagram illustrating a method for correcting a conveyance direction of the printing belt.

FIG. 19 is a diagram illustrating a method for correcting an ejection timing.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### (1) Image Forming Apparatus

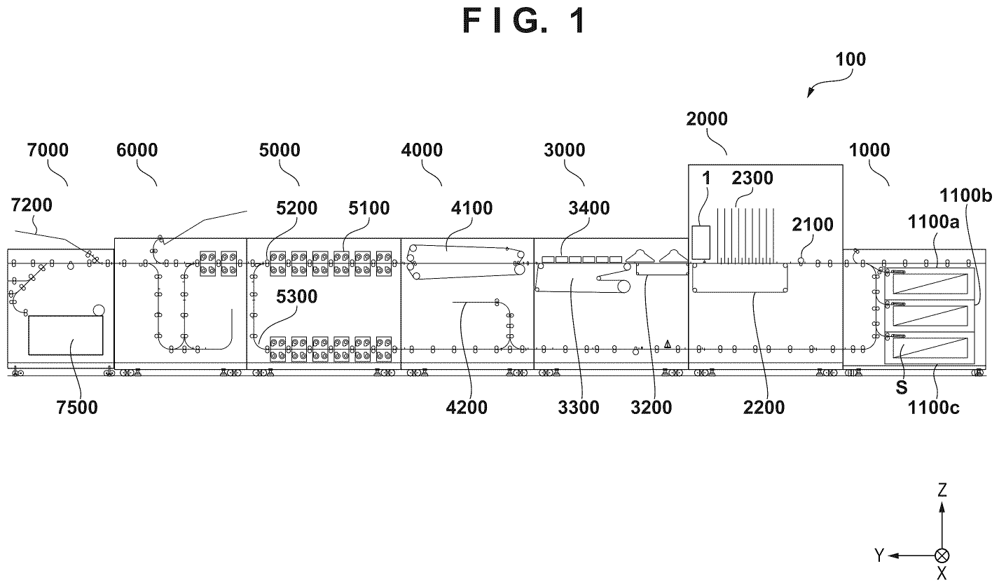

FIG. 1 is a schematic diagram showing one example of a schematic configuration of an inkjet recording apparatus 100. Note that a Z-direction is a height direction of the inkjet recording apparatus 100. A Y-direction is substantially parallel to the direction in which a sheet is conveyed. An X-direction is a width direction of a sheet S. Note that the width direction of the sheet S may be referred to as a main scanning direction. A direction parallel to the direction in which the sheet S is conveyed may be referred to as a sub-scanning direction.

The inkjet recording apparatus 100 is a cut sheet-type image forming apparatus that forms an ink image on the sheet S using two liquids: a reaction solution and ink. The sheet S on which the ink image is formed may be referred to as a recorded product, an output product, or a product. The ink contains, for example, a resin component, water, a water-soluble organic solvent, a coloring material, a wax, and an additive. However, these are merely examples.

The inkjet recording apparatus 100 includes a feeding module 1000, a printing module 2000, a drying module 3000, a fixing module 4000, a cooling module 5000, a reversing module 6000, a discharging and stacking module 7000, and the like. A cut paper-like sheet S supplied from the feeding module 1000 is conveyed along a conveyance path, processed in each module, and discharged to the discharging and stacking module 7000.

The feeding module 1000 includes three storages 1100a to 1100c that accommodate sheets S. The storages 1100a to 1100c can be pulled out to the front side of the inkjet recording apparatus 100. The sheets S are fed one by one from the storages 1100a to 1100c by separation belts and conveyance rollers, and conveyed to the printing module 2000. Note that the number of storages 1100a to storages 1100c need only be one or more.

The printing module 2000 includes a sheet correcting unit 2100, a belt unit 2200, and a recording unit 2300. The sheet correcting unit 2100 corrects the tilt (misalignment) and the position of the sheet S conveyed from the feeding module 1000, and conveys the sheet S to the belt unit 2200. The recording unit 2300 is disposed to face the belt unit 2200 across the conveyance path. The recording unit 2300 performs recording processing (printing) on the conveyed sheet S using the recording head from above to form an image. The sheet S is attracted to and conveyed by the belt unit 2200. Accordingly, an appropriate clearance is ensured between the recording head and the sheet S. Also, a plurality of recording heads may be arranged along the conveyance direction. In Examples, four line-type recording heads corresponding to inks of four colors (Y: yellow, M: magenta, C: cyan, Bk: black) and one line-type recording head that ejects a reaction solution C0 are provided. Each of the number of colors and the number of recording heads is not limited to five. For example, three line-type recording heads for special colors C1, C2, and C3 that are different from Y, M, C, and Bk may be added. Examples of inkjet recording methods include a method using a heating element, a method using a piezoelectric element, a method using an electrostatic element, and a method including a MEMS element. “MEMS” is an abbreviation for micro-electromechanical system.

Each of the inks of four colors is supplied to the recording head from an ink tank (not shown) via an ink tube. The belt unit 2200 further conveys downstream the sheet S on which the image is printed by the recording unit 2300. The inline scanner 1 (reader) may be disposed on the downstream side of the recording unit 2300. The inline scanner 1 detects the misalignment and color density of an image formed on the sheet S. The detection results are used to correct images that are to be subsequently printed.

The drying module 3000 reduces the liquid content in the ink applied onto the sheet S by the recording unit 2300, and improves the fixability between the ink and the sheet S. The drying module 3000 includes a decoupling unit 3200, a drying belt unit 3300, and a warm air blowing unit 3400. The sheet S on which the image has been printed by the recording unit 2300 of the printing module 2000 is conveyed to the decoupling unit 3200 disposed in the drying module 3000. The decoupling unit 3200 conveys the sheet S further downstream while holding the sheet S using wind pressure from above and frictional force of the belt. This suppresses the misalignment of the sheet S on the belt unit 2200. The sheet Sis conveyed from the decoupling unit 3200 to the drying belt unit 3300. The drying belt unit 3300 conveys the sheet S while attracting the sheet S. The warm air blowing unit 3400 is disposed on the drying belt unit 3300. The warm air blowing unit 3400 applies hot air to the sheet S to dry the ink applied surface of the sheet S. The drying belt unit 3300 conveys the sheet S to the fixing module 4000.

The drying module 3000 heats and dries the liquid content of the reaction solution and the ink applied to the sheet S. This facilitates evaporation of water in the reaction solution and the ink, and suppresses cockling of the sheet S.

Any device that can perform heat drying will be sufficient for the drying module 3000. For example, the drying module 3000 may include a warm air dryer or heater. There is no particular limitation on the type of heater. For example, an electric wire heater or an infrared heater may be used as the heater.

The fixing module 4000 includes a fixing belt unit 4100. The fixing belt unit 4100 includes an upper belt unit and a lower belt unit. The upper belt unit and the lower belt unit are heated, and the sheet S passes therebetween. As a result, an ink solvent sufficiently permeates the sheet S.

The cooling module 5000 includes a plurality of cooling units 5100 that cool the high-temperature sheet S conveyed from the fixing module 4000. The cooling unit 5100, for example, draws outside air into a cooling box using a fan, increases the pressure inside the cooling box, and exposes the sheet S to atmosphere from a nozzle formed in a conveyance guide. As a result, the sheet S is cooled. The cooling units 5100 are disposed on both sides of the conveyance path in the height direction thereof. As a result, both sides of the sheet S are cooled. A switching unit 5200 for switching the conveyance path may be provided in the cooling module 5000. The switching unit 5200 switches between conveyance of the sheet S to the reversing module 6000 and conveyance of the sheet S to a double-sided conveyance path used during double-sided printing. During double-sided printing, the sheet S is conveyed to the double-sided conveyance path 5300 provided in the lower portion of the cooling module 5000. Also, the sheet S is conveyed through the fixing module 4000, the drying module 3000, the printing module 2000, and the feeding module 1000. As a result, the sheet S is conveyed again to the sheet correcting unit 2100, the belt unit 2200, and the recording unit 2300 of the printing module 2000. Then, the recording unit 2300 prints an image on the second side of the sheet S.

The double-sided conveyance path of the fixing module 4000 may be provided with a reversing unit 4200 for reversing the front and back sides of the sheet S. The reversing module 6000 also includes a reversing unit 6400. The reversing unit 6400 reverses the front and back sides of the sheet S to be conveyed. As a result, the front and back sides (face-down/face-up) of the sheet S to be discharged can be freely selected.

The discharging and stacking module 7000 includes a top tray 7200 and a stacking unit 7500. The top tray 7200 and the stacking unit 7500 align and stack the sheets S conveyed from the reversing module 6000.

### (2) Printing Module

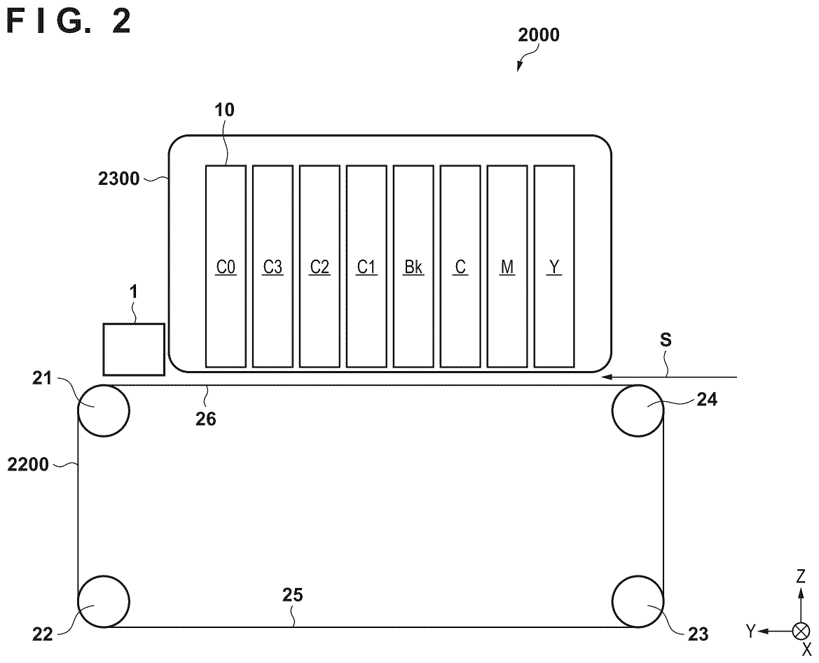

FIG. 2 is a schematic cross-sectional view of the printing module 2000. The printing module 2000 is an image forming unit that forms an ink image on the sheet S by performing recording processing from above on the sheet S that is being conveyed, using five recording heads 10 (eight recording heads 10 when using a special color recording head). The sheet S needs to be stably conveyed in the image forming unit. In particular, the sheet S passing directly under the recording heads 10 needs to be stably conveyed. In view of this, the belt unit 2200 attracts and conveys the sheet S.

The printing belt 25 of the belt unit 2200 is stretched over stretch rollers 21 to 24. A belt surface (conveyance surface) stretched between the stretch roller 21 and the stretch roller 24 is referred to as an image forming surface 26. The recording heads 10 form an image by ejecting ink (droplets) onto the sheet S conveyed by the image forming surface 26. The printing belt 25 has a plurality of suction holes (not shown) for suctioning the sheet S. By sucking the sheet S through the plurality of suction holes present in the image forming surface 26, the sheet S is tightly attracted to the image forming surface 26, and the sheet S is stably conveyed. Note that a configuration of the printing belt 25 is not limited to the configuration in which the sheet S is attracted to the printing belt 25 by sucking the sheet S through the suction holes of the printing belt 25. For example, a charge applying unit may be added in order to apply charges to the surface of the printing belt 25. As a result, the sheet S may be electrostatically attracted to the printing belt 25. The printing belt 25 functions as a sheet carrying member (belt member) that carries the sheet S in this manner. The printing belt 25 is manufactured from a single belt-shaped PET sheet rolled up into a roll. PET is an abbreviation for polyethylene terephthalate. A plurality of suction holes are formed in the PET sheet. Then, the PET sheet is cut to a predetermined length. A leading end and a rear end of the PET sheet are joined through laser welding. As a result, an endless printing belt 25 is manufactured.

### (3) Belt Unit

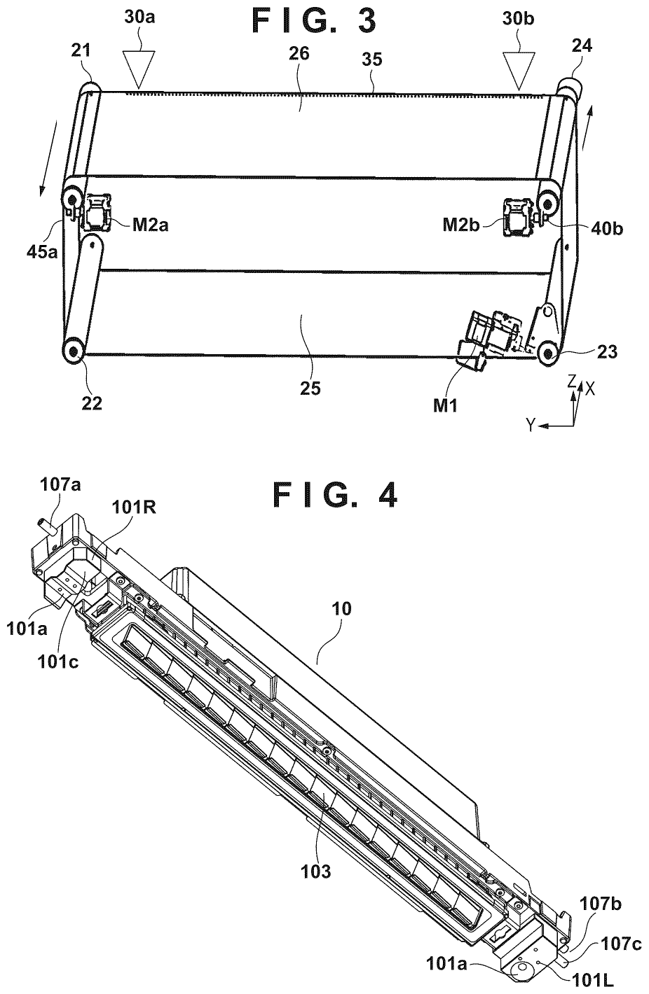

FIG. 3 shows a belt unit 2200. The printing belt 25 is stretched over stretch rollers 21 to 24. In particular, the stretch roller 21 is a drive roller that rotationally drives the printing belt 25. A rotation shaft of the stretch roller 21 is rotatably supported by a bearing 40a. A motor M2a moves the stretch roller 21 in the X-direction by moving the bearing 40a in the X-direction.

The stretch roller 22 is a tension roller that stretches the printing belt 25 by pressing the printing belt 25 from the inner peripheral surface side of the printing belt 25 to the outer peripheral surface side of the printing belt 25. The stretch roller 23 is a steering roller. The motor M1 moves one shaft end of the stretch roller 23, and tilts the stretch roller 23. As a result, meandering of the printing belt 25 is suppressed.

The stretch roller 24 is a driven roller that rotates as the printing belt 25 rotates. A rotation shaft of the stretch roller 24 is rotatably supported by a bearing 40b. A motor M2b moves the stretch roller 24 in the X-direction by moving the bearing 40b in the X-direction.

The sheet S is attracted to the image forming surface 26, thus forming a single body with the printing belt 25. Thus, the accuracy (e.g., squareness) of the image formed on the sheet S is also improved by accurately positioning the image forming surface 26. The two stretch rollers 21 and 24 form the image forming surface 26.

A belt sensor 30a is disposed in a vicinity of the stretch roller 21. The belt sensor 30a detects a detection shape 35 disposed at an end portion of the printing belt 25. A belt sensor 30b is disposed in a vicinity of the stretch roller 24. The belt sensor 30b detects a detection shape 35 disposed at the end portion of the printing belt 25. The detection results of the belt sensors 30a and 30b are used to identify the position at which the end portion of the printing belt 25 passes and the conveyance direction of the printing belt 25. The motors M2a and M2b independently move the stretch rollers 21 and 24 in the X-direction based on the detection results of the belt sensors 30a and 30b, and thus the position of the printing belt 25 is adjusted.

The detection shape 35 may be, for example, a plurality of holes with a major axis of approximately 1 mm. The plurality of holes may be provided over one peripheral surface of the printing belt 25 at intervals of approximately 6 mm. A line connecting the center positions of the plurality of holes is a straight line, and the straight line is parallel to the end portion of the printing belt 25. The belt sensors 30a and 30b may be contact image sensors (CISs). The center positions of the holes read by the belt sensors 30a and 30b may be calculated. When the center position of a hole detected by the belt sensor 30a in the X-direction matches the center position of a hole detected by the belt sensor 30b in the X-direction, then the printing belt 25 is parallel to the Y-direction. Also, when the printing belt 25 is moved in the X-direction, the amount of movement of the center position of the hole detected by the belt sensor 30a in the X-direction, and the amount of movement of the center position of the hole detected by the belt sensor 30b in the X-direction are calculated. When two movement amounts are equal to each other, it means that the printing belt 25 has moved in parallel to the X-direction. The conveyance direction of the printing belt 25 can be changed by intentionally making the two movement amounts different from each other.

### (4) Recording Head

FIG. 4 is a perspective view of the recording head 10. As shown in FIG. 4, the recording head 10 includes a plurality of nozzle plates 103 arranged side-by-side in the X-direction. Each of the plurality of nozzle plates 103 has a plurality of nozzles that eject ink (droplets). Positioning units 101L and 101R are arranged at both ends of the recording head 10, and position the recording head 10 in the X-direction, the Y-direction, and the Z-direction. A bottom surface of the positioning unit 101L is provided with a first contact portion 101a. The first contact portion 101a has a recessed portion having a conical inclined surface. A bottom surface of the positioning unit 101R is provided with a second contact portion 101b and a third contact portion 101c. The second contact portion 101b has a groove. A Z-Y cross section of the groove is substantially V-shaped. The third contact portion 101c has a flat portion.

A first pin 107a extending in the X-direction is provided at one end of the recording head 10 in the longitudinal direction (X-direction) thereof. A second pin 107b and a third pin 107c that extend in the X-direction are provided at an opposite end of the recording head 10 in the longitudinal direction (X-direction) thereof. A straight line connecting the center of the first contact portion 101a and the center of the second contact portion 101b is parallel to the arrangement direction of the plurality of nozzle plates 103.

### (5) Recording Head Support Structure

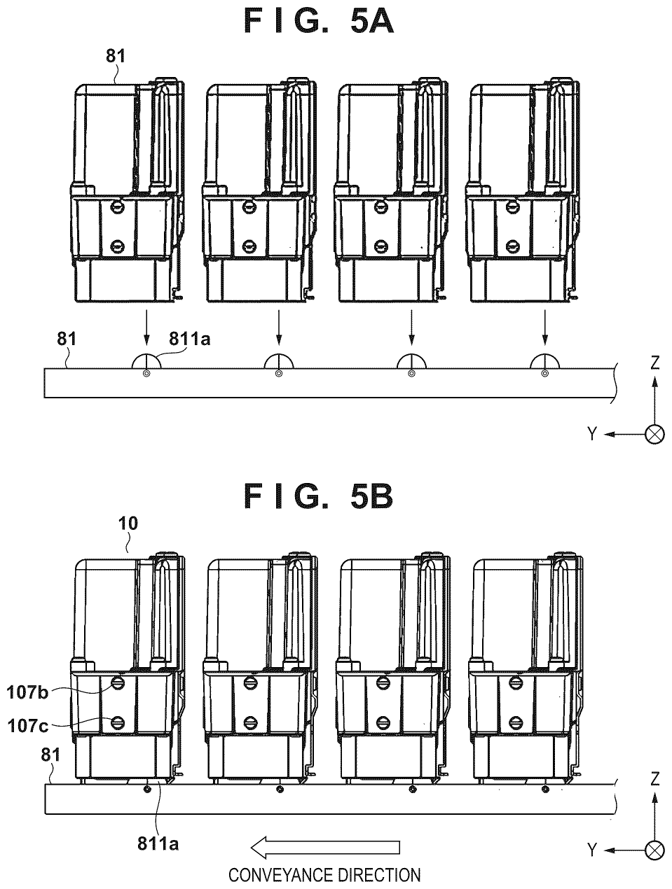

FIG. 5A shows four recording heads 10 and positioning members 811a provided on a housing 81 of the belt unit 2200. FIG. 5B shows a state in which the four recording heads 10 are positioned with respect to the housing 81. Each positioning member 811a has a shape corresponding to the first contact portion 101a. In this example, the positioning member 811a is a hemispherical protruding portion. As the recording head 10 is lowered toward the housing 81, the positioning member 811a is fitted to the first contact portion 101a. As a result, the recording head 10 is positioned with respect to the housing 81.

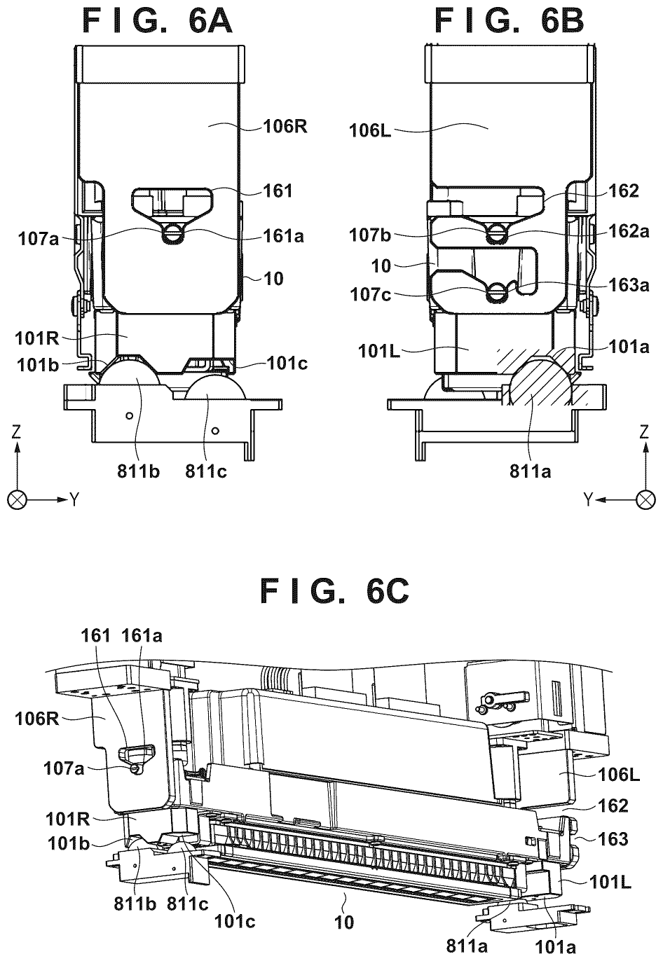

FIG. 6A shows one end side of the recording head 10. FIG. 6B shows the opposite end side of the recording head 10. FIG. 6C is a perspective view of the recording head 10. Head holders 106R and 106L are support members that support the recording head 10. As the head holders 106R and 106L are lowered from a retracted position toward a printing position, the recording head 10 is also lowered. As a result, the positioning member 811a is fitted to the first contact portion 101a. Also, the positioning member 811b provided on the housing 81 is fitted to the second contact portion 101b. The third contact portion 101c comes into or engages with the positioning member 811c. As a result, both ends of the recording head 10 in the longitudinal direction are firmly positioned. The head holder 106R is provided with an opening 161 having an area larger than the cross-sectional shape of the first pin 107a. A bottom portion of the opening 161 is provided with a first groove 161a with which the first pin 107a of the recording head 10 engages.

The head holder 106L is provided with substantially U-shaped openings 162 and 163. A bottom portion of the opening 162 is provided with a second groove 162a. A bottom portion of the opening 163 is provided with a third groove 163a. A second pin 107b of the recording head 10 engages with the second groove 162a. A third pin 107c of the recording head 10 engages with the third groove 163a.

The first pin 107a is locked in the first groove 161a, the second pin 107b is locked in the second groove 162a, and the third pin 107c is locked in the third groove 163a in this manner, and thus the recording head 10 is positioned in the Z-direction and the Y-direction.

### (6) Inline Scanner

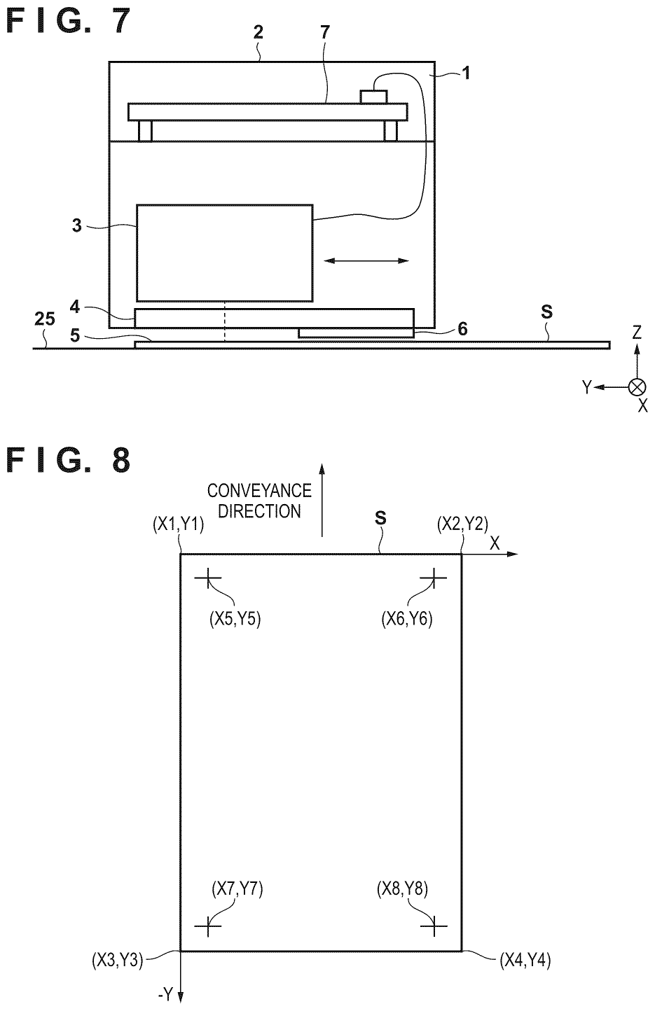

FIG. 7 shows the inline scanner 1. The inline scanner 1 is an image reading apparatus provided on the downstream side of the recording heads 10 in the direction in which the sheet S is conveyed (Y-direction). The inline scanner 1 can read an image formed on the sheet S conveyed by the printing belt 25.

An optical box 3, a reading glass 4, and an image processing board 7 are provided in a housing 2 of the inline scanner 1. The optical box 3 reads the shape of the sheet S and a test image via the reading glass 4. The optical box 3 is movable in the Y-direction. The reading position 5 of the optical box 3 is movable between a position at which the sheet S is read and a shading sheet 6. The result of reading the shading sheet 6 is used to correct the shading of the image acquired by the optical box 3. The shading sheet 6 may be referred to as a “white reference plate”. Similarly to the recording head 10, the inline scanner 1 may be positioned by coming into contact with a positioning member provided on the housing 81 of the belt unit 2200.

### (7) Correction of Relative Tilt (Misalignment) Between Reference Head and Other Heads

The recording unit 2300 includes eight recording heads 10. Images drawn by the eight recording heads 10 need to be parallel to each other. The relative tilt between eight recording heads 10 may be corrected by adjusting the tilts of seven recording heads 10 with respect to the tilt of one recording head 10 (reference head) out of the eight recording heads 10.

The printing belt 25 conveys the sheet S on which the test image (test pattern) has been formed. The positions of the remaining seven recording heads 10 are adjusted with respect to one recording head 10 (reference head), based on the result of reading the test image.

Incidentally, in order to ensure the squareness of an image, the tilt between the printing belt 25 and the recording head 10 needs to be adjusted to a target value presumed in terms of design. The sheet S on which the test image has been formed is read by the inline scanner 1. The reading result may be used to ensure the squareness of the image. However, in this case, the tilt between the printing belt 25 and the inline scanner 1 need to be calibrated.

### (8) Test Image

FIG. 8 shows the sheet S on which the test images, which are used to correct squareness, have been formed. The test images may be four cross marks provided respectively in the vicinities of the four corners of the sheet S. Note that the test images may be used to adjust a conveyance position of the sheet S (carrying position) with respect to the printing belt 25. The test images may be used to adjust a writing start position for the sheet S in the main scanning direction and a writing start position for the sheet S in the sub-scanning direction. Also, the test images may be used to adjust the magnification of the image in the sub-scanning direction and the magnification of the image in the main scanning direction.

According to FIG. 8, the coordinates of a first corner of the sheet S are defined as (X1, Y1). The coordinates of a second corner of the sheet S are defined as (X2, Y2). The coordinates of a third corner of the sheet S are defined as (X3, Y3). The coordinates of a fourth corner of the sheet S are defined as (X4, Y4). The coordinates of a first mark are defined as (X5, Y5). The coordinates of a second mark are defined as (X6, Y6). The coordinates of a third mark are defined as (X7, Y7). The coordinates of a fourth mark are defined as (X8, Y8).

Note that a direction parallel to the conveyance direction (Y-direction) may be referred to as a sub-scanning direction. The X-direction orthogonal to the conveyance direction may also be referred to as a main scanning direction. The coordinates (X1, Y1) to (X8, Y8) are calculated based on the results obtained when the inline scanner 1 reads the sheet S on which the test images have been formed.

### (9) Front/Back Misalignment Caused by Misalignment of Squareness of Image

If the printing belt 25 and a recording head 10 are misaligned, then the squareness of an image will be lost. As a result, the position of an image formed on the first side of the sheet S does not match the position of an image formed on the second side of the sheet S. This is called front/back misalignment.

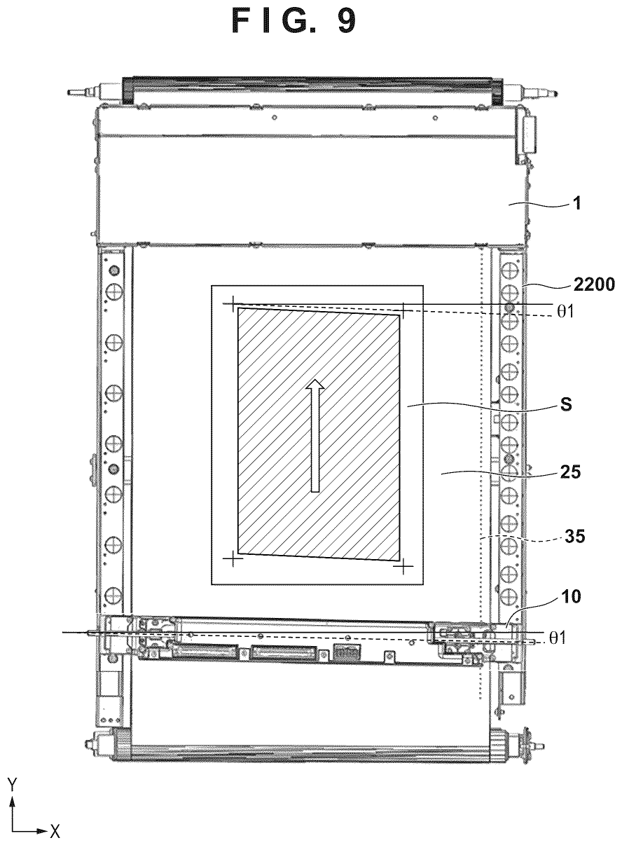

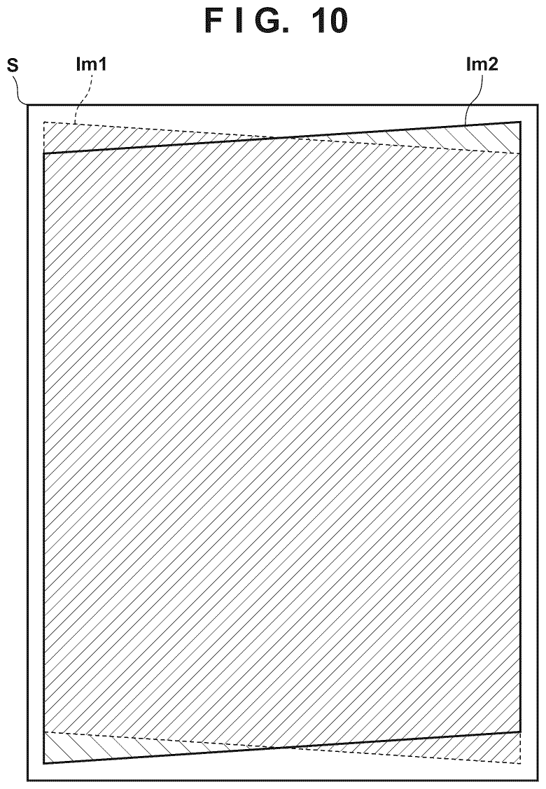

FIG. 9 shows a relationship among the sheet S carried and conveyed by the printing belt 25, the recording head 10, and the inline scanner 1. θ1 indicates an angle between the direction orthogonal to the conveyance direction of the printing belt 25 and the longitudinal direction of the recording head 10. θ1 indicates a deviation angle of the squareness of the recording head 10 with respect to the conveyance direction of the printing belt 25. It is presumed that the recording head 10 ejects ink from a plurality of nozzles arranged in the direction perpendicular to the conveyance direction of the printing belt 25. Therefore, in a case where the deviation angle of squareness is θ1, then the image formed on the sheet S will be a parallelogram.

In a case where images are formed on both sides of the sheet S, the sheet S on which an image is formed on the first side is subjected to reverse processing, and conveyed to the printing module 2000 again. At this time, an image formed on the second side is also a parallelogram according to θ1.

FIG. 10 shows the relationship between an image Im1 formed on the first side of the sheet S and an image Im2 formed on the second side of the sheet S. The image Im1 and the image Im2 are tilted in opposite directions. That is, the four corners of the image Im1 do not match the four corners of the image Im2.

Degradation of squareness results in image distortion and image misalignment. A skilled person may determine the positions of the four marks formed on the sheet S using a scale, and determine θ1 based on the positions of the four marks. However, this requires a skilled person. In a case where the position of a recording head 10 is measured using a position sensor in order to ensure the squareness of an image, a position sensor is required for each recording head 10. If eight recording heads 10 are provided, eight position sensors are required. It is extremely difficult even for a skilled person to directly measure the amount of misalignment between the printing belt 25 and a recording head 10.

Furthermore, as a result of the inline scanner 1 reading the test images formed on the sheet S, θ1 can be measured without relying on a skilled person. However, in a case where the inline scanner 1 and the printing belt 25 are misaligned, θ1 will be inaccurate.

### (10) Method for Determining Tilt Correction Value

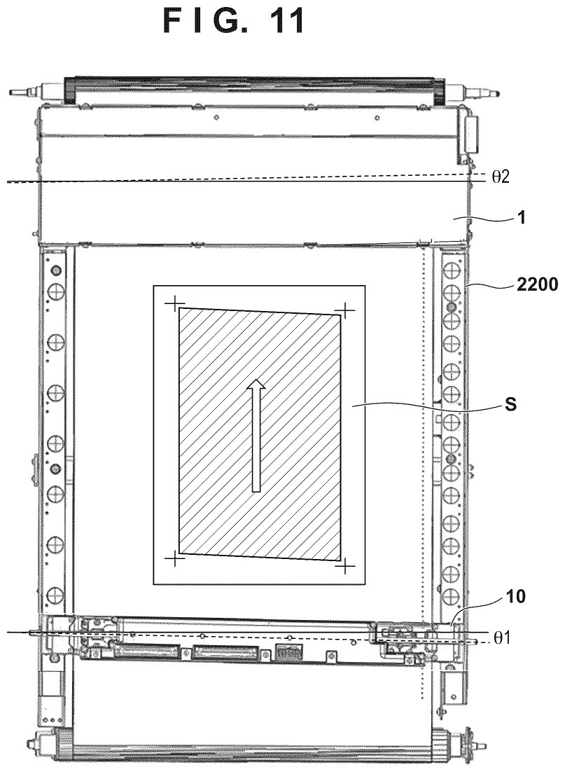

FIG. 11 shows a tilt θ1 (a misalignment θ1) of the recording head 10 with respect to the printing belt 25 and a tilt θ2 of the inline scanner 1 with respect to the printing belt 25. Hereinafter, it is presumed that the positions of the four corners of the sheet S are acquired by the inline scanner 1.

The recording head 10 forms test images (e.g., cross marks) at the four corners of the sheet S conveyed by the printing belt 25. The printing belt 25 conveys the sheet S to the inline scanner 1. The inline scanner 1 can read the test images formed at the four corners of the sheet S conveyed by the printing belt 25. As a result, the coordinates (X5, Y5) to (X8, Y8) of the test images at the four corners are acquired.

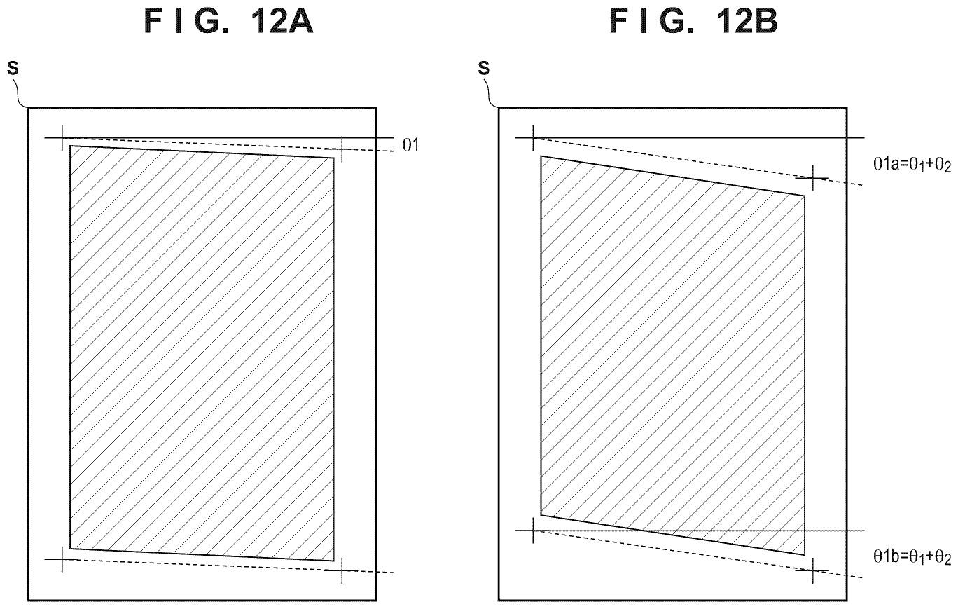

FIG. 12A shows the tilt θ1 of test images formed on the sheet S. FIG. 12B shows the result of reading the test images having the tilt θ1. The reading result is affected not only by the tilt θ1 but also by a tilt θ2. In view of this, the influence of the tilt θ2 needs to be reduced from the reading result. The tilt θ2 (which may also be referred to as a “calibration value θ2”) may be acquired in advance and stored in a memory or the like.

$$\\ \begin{matrix}θ 1 a = arc tan ( ( Y 6 - Y 5 ) / ( X 6 - X 5 ) ) & Eq . 1\end{matrix}$$

θ1a indicates a value obtained by measuring the tilt of the images on the leading end side in the conveyance direction of the sheet S.

$$\\ \begin{matrix}θ 1 b = arc tan ( ( Y 8 - Y 7 ) / ( X 8 - X 7 ) ) & Eq . 2\end{matrix}$$

θ1b indicates a value obtained by measuring the tilt of the images on the rear end side in the conveyance direction of the sheet S.

$$\\ \begin{matrix}θ 1 = ( θ 1 a + θ 1 b ) / 2 - θ 2 & Eq . 3\end{matrix}$$

The tilt θ1 is calculated from the statistical values (e.g., average) of the measured values θ1a and θ1b in this manner. Note that the following calculation may be used to simplify calculation. That is, the tilt θ1 may be calculated from two test images on the leading side, or two test images on the rear side.

$$\\ \begin{matrix}θ 1 = θ 1 a - θ 2 & Eq . 4\end{matrix}$$

$$\\ \begin{matrix}θ 1 = θ 1 b - θ 2 & Eq . 5\end{matrix}$$

The tilt θ1 acquired in this manner is used as a correction value for the tilt of the recording head 10.

Although the tilt θ is calculated from the test images formed on one sheet S in this example, this is merely an example. The recording head 10 may form test images on N sheets S, and the inline scanner 1 may read the test images formed on the N sheets S. N represents an integer of 2 or more. In this case, N θ1a and N θ1b are acquired. Thus, the average of N θ1a and the average of N θ1b are substituted into the equation Eq. 3. This reduces the influence of reading errors made by the inline scanner 1. As a result, the accuracy of correcting the misalignment between the recording head 10 and the printing belt 25 is improved.

### (11) Method for Correcting Tilt

Hereinafter, the tilt θ1 will be expressed as a correction value θ1. There are a plurality of methods in which the correction value θ1 is used to correct squareness.

### (11-1) Correction of Conveyance Direction of Printing Belt 25

As described in association with FIG. 3, the motors M2a and M2b can change the conveyance direction of the printing belt 25. The belt sensors 30a an 30b can detect the conveyance direction of the printing belt 25. Therefore, the motors M2a and M2b change the conveyance direction of the printing belt 25 such that the conveyance direction of the printing belt 25 detected by the belt sensors 30a and 30b deviates by the correction value θ1. As a result, orthogonality between the printing belt 25 and the recording head 10 is ensured with high precision.

### (11-2) Offset Ink Ejection Timing

A plurality of nozzles are arranged in the longitudinal direction of the recording head 10. Thus, the timings at which ink is ejected from the plurality of nozzles may be shifted according to the correction value θ1 and the positions of the nozzles in the longitudinal direction.

It is presumed as an example that M nozzles are arranged side-by-side in the X-direction. In this case, offset value Offset_i applied to the ejection timing of the i-th nozzle is as follows.

$$\\ \begin{matrix}Offset\_i = ( x ( i ) / v ) tan θ 1 & Eq . 6\end{matrix}$$

where x(i) indicates the position of the i-th nozzle in the X-direction. v indicates the conveyance speed of the printing belt 25. Thus, the ejection timing t_i of the i-th nozzle is calculated using the following equation.

$$\\ \begin{matrix}t\_i = t 0 \_i - Offset\_i & Eq . 7\end{matrix}$$

where t0_i indicates the ejection timing of the i-th nozzle used when forming the test image for determining the correction value θ1. t0_i and Offset_i are stored in a memory or the like.

### (11-3) Transformation of Image in Advance (Predistortion)

The original image may be transformed in an opposite direction according to the correction value θ1. That is, an inverse characteristic of the tilt characteristic in the printing module 2000 are applied to the original image in advance. As a result, the tilt characteristics in the printing module 2000 are canceled out by the transformation of the original image.

### (11-4) Correction of Tilt of Recording Head 10

The tilt of the recording head 10 may be corrected using a motor or the like according to the correction value θ1. In this case, a motor is required to move each of the eight recording heads 10.

### (12) Method for Determining θ2

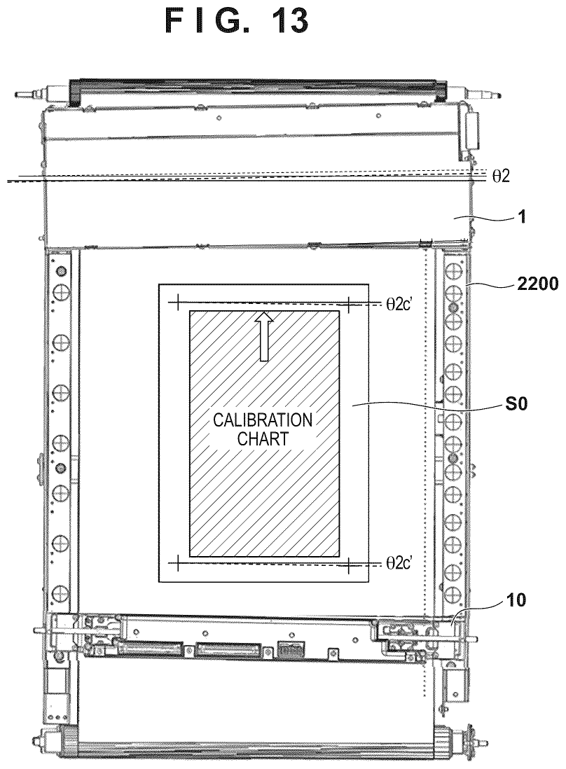

FIG. 13 shows a method for determining the tilt θ2. A calibration chart S0 is a sheet S on which four test images are accurately formed. However, the four test images formed on the calibration chart S0 may have a tilt θ2c′. In this case, the tilt θ2c′ is measured in advance using a 2.5-dimensional measuring apparatus or the like.

The printing belt 25 conveys the calibration chart S0, and the inline scanner 1 reads the calibration chart S0. The tilt θ2c of the four test images is measured from the result of reading the calibration chart S0. In this case, the tilt θ2, which is a calibration value, is calculated using the following equation.

$$\\ \begin{matrix}θ 2 = θ 2 c - θ 2 {c}^{{}_{} ′} & Eq . 8\end{matrix}$$

The tilt θ2 is stored in a storage device of the inline scanner 1 or the like. The calibration chart S0 is a sheet that has a small change in moisture content and has a stable shape, such as a resin film or paper coated with resin. θ2 may be acquired, for example, when the printing module 2000 is shipped from the factory or when the printing module 2000 is installed in the customer's room.

### (13) Controller

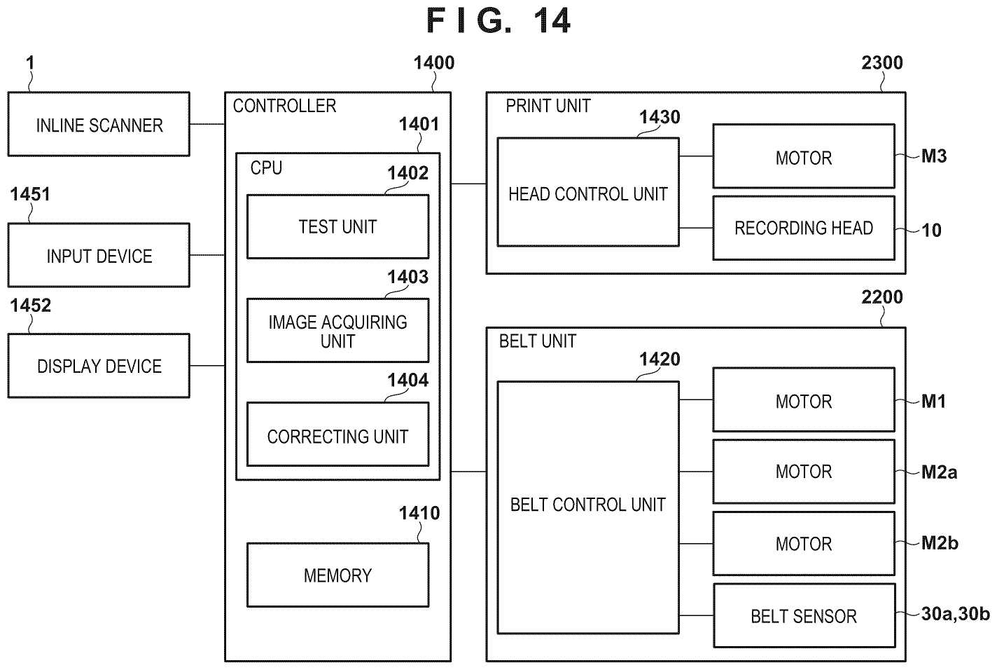

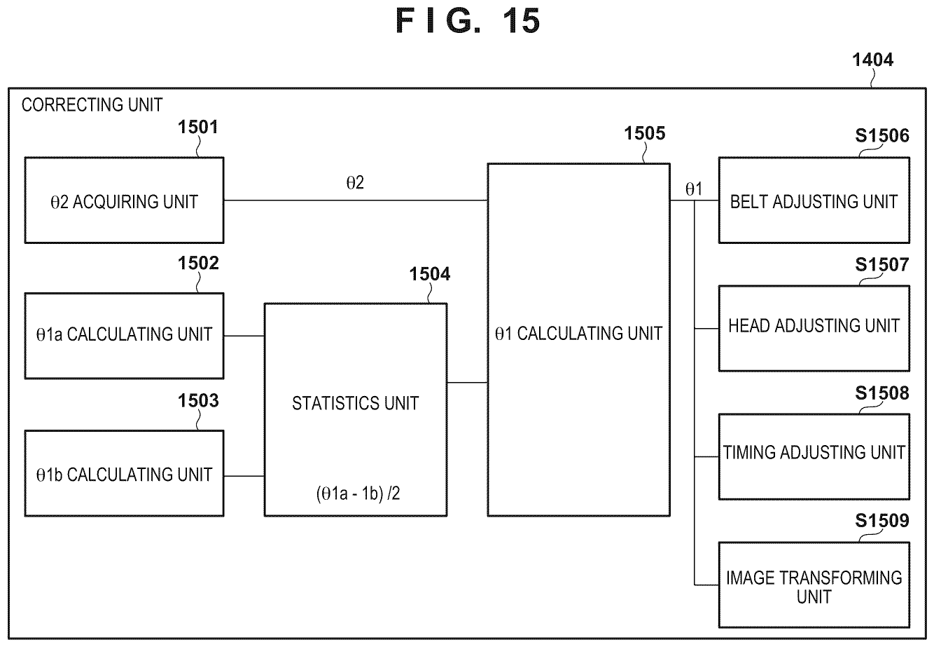

FIG. 14 shows a controller 1400 of the inkjet recording apparatus 100. The controller 1400 includes a CPU 1401 and a memory 1410. The CPU 1401 realizes various functions by executing control programs stored in the memory 1410. All or some of the functions realized by the CPU 1401 may be realized by other hardware circuits such as a DSP, an ASIC, or an FPGA. DSP is an abbreviation for a digital signal processor. ASIC is an abbreviation for an application-specific integrated circuit. FPGA is an abbreviation for a field-programmable gate array. The memory 1410 is a storage device that may include a volatile memory (e.g., RAM), a non-volatile memory (e.g., ROM), a hard disk drive (HDD), a solid state drive (SSD), and the like. The controller 1400 may be connected to an input device 1451 for receiving a user input and a display device 1452 for displaying information to a user.

A test unit 1402 controls the inkjet recording apparatus 100 to form test images on the sheet S. An image acquiring unit 1403 controls the inline scanner 1 so that the inline scanner 1 reads the test images formed on the sheet S. Accordingly, the image acquiring unit 1403 acquires the result of reading the test images. A correcting unit 1404 determines a correction value θ1 based on the result of reading the test images and the tilt θ2 (calibration value) stored in the memory 1410, and corrects the squareness of an image.

The recording unit 2300 includes a head control unit 1430. The head control unit 1430 controls the recording head 10 according to the image signals output from the CPU 1401. The head control unit 1430 drives the motor M3 in accordance with a control command output from the correcting unit 1404, and corrects the tilt of the recording head 10. The motor M3 is optional.

The belt unit 2200 includes a belt control unit 1420. The belt control unit 1420 controls the motor M1 and reduces meandering of the printing belt 25. The belt control unit 1420 controls the belt sensors 30a and 30b and detects the conveyance direction of the printing belt 25. The belt control unit 1420 controls the motors M2a and M2b according to the correction value θ1 such that the correction value θ1 is applied to the conveyance direction of the printing belt 25.

FIG. 15 shows details of the correcting unit 1404. A θ2 acquiring unit 1501 acquires the tilt θ2 from the memory 1410. Note that the θ2 acquiring unit 1501 may, for example, calculate the tilt θ2 using the equation Eq. 6.

A θ1a calculating unit 1502 calculates the tilt θ1a based on the result obtained when the inline scanner 1 reads the test images. For example, the θ1a calculating unit 1502 may, for example, calculate the tilt θ1a using the equation Eq. 1.

A θ1b calculating unit 1503 calculates the tilt θ1b based on the result obtained when the inline scanner 1 reads the test images. For example, the θ1b calculating unit 1503 may, for example, calculate the tilt θ1b using the equation Eq. 2.

A statistics unit 1504 determines a statistical value (e.g., the average of the tilt θ1a and the tilt θ1b) based on the tilt θ1a and the tilt θ1b. A θ1 calculating unit 1505 determines the tilt θ1 (correction value θ1) based on the tilt θ2 and the statistical value.

A belt adjusting unit 1506, a head adjusting unit 1507, a timing adjusting unit 1508, and an image transforming unit 1509 are optional. It is sufficient that one or more of these units are present. The belt adjusting unit 1506 transmits a control command to the belt control unit 1420 to control the conveyance direction of the printing belt 25 according to the correction value θ1. The head adjusting unit 1507 transmits a control command to the head control unit 1430 to adjust the tilt of the recording head 10 according to the correction value θ1. The timing adjusting unit 1508 calculates offset values for the ejection timings of a plurality of heads provided in the recording head 10 according to the correction value θ1, and sets the offset values of the ejection timings of the heads in the head control unit 1430. The head control unit 1430 offsets the ejection timing of each head based on the reference timing according to the offset value of the ejection timing of the head. The image transforming unit 1509 transforms the original image in advance according to the correction value θ1. This may be referred to as “predistortion”.

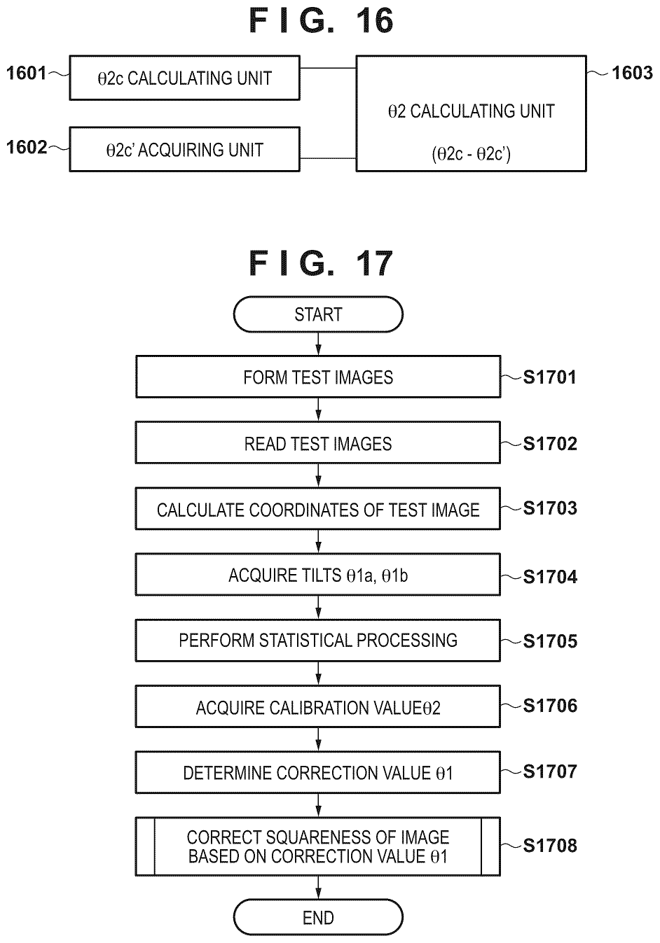

FIG. 16 shows an example of the θ2 acquiring unit 1501. A θ2c calculating unit 1601 causes the inline scanner 1 to read the calibration chart S0, and calculates the tilt 2c based on the reading result. A θ2c′ acquiring unit 1602 reads θ2c′ from the memory 1410, and receives θ2c′ input by an operator through the input device 1451. The θ2 calculating unit 1603 calculates the tilt θ2 using the equation Eq. 6.

### (14) Flowchart

FIG. 17 is a flowchart showing a control method executed by the CPU 1401.

In step S1701, the CPU 1401 (the test unit 1402) controls the inkjet recording apparatus 100 to form the test images on the sheet S. For example, the feeding module 1000 starts feeding and conveying the sheet S according to a feeding command from the CPU 1401. The printing module 2000 forms test images on the sheet S while conveying the sheet S according to the feeding command from the CPU 1401.

In step S1702, the CPU 1401 (the image acquiring unit 1403) reads the test images using the inline scanner 1. Accordingly, the result of reading the test images (image data) is acquired.

In step S1703, the CPU 1401 (the correcting unit 1404) acquires the coordinates of the test images based on the result of reading the test images. As shown in FIG. 8, the coordinates (X5, Y5) to (X8, Y8) of the four test images are acquired.

In step S1704, the CPU 1401 (the θ1a calculating unit 1502, the θ1b calculating unit 1503) acquires the tilts θ1a and θ1b from the coordinates (X5, Y5) to (X8, Y8) of the four test images. For example, the tilts θ1a and θ1b may be calculated using the equations Eq. 1 and Eq. 2.

In step S1705, the CPU 1401 (the statistics unit 1504) performs statistical processing on the tilts θ1a and θ1b. As shown in the equation Eq. 3, the statistical processing may be processing for determining the average of the tilts θ1a and θ1b. Also, in a case where the results of reading N sheets S are present, the average of the N averages acquired from the N sheets S may be further determined.

In step S1706, the CPU 1401 (the θ2 acquiring unit 1501) acquires the calibration value θ2. The calibration value θ2 may be acquired from the memory 1410. Alternatively, the inline scanner 1 may read the calibration chart S0, and the CPU 1401 may calculate the calibration value θ2 based on the reading result. At this time, the equation Eq. 8 may be used.

In step S1707, the CPU 1401 (the θ1 calculating unit 1505) determines the correction value θ1 based on the statistical values of the tilts θ1a and θ1b and the calibration value θ2. This is as described for the equation Eq. 3.

In step S1708, the CPU 1401 (the belt adjusting unit 1506, the head adjusting unit 1507, the timing adjusting unit 1508, and the image transforming unit 1509) corrects the squareness of an image based on the correction value θ1. As described above, there are at least four types of squareness correction methods.

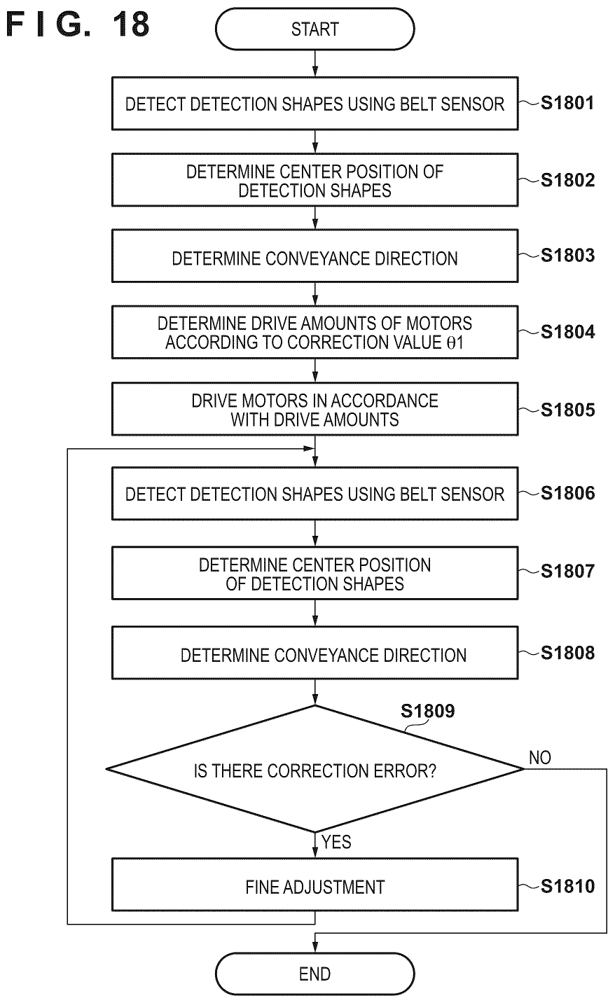

FIG. 18 shows a method for correcting the squareness of an image by modifying the conveyance direction of the printing belt 25. The following processing shows step S1708 in detail.

In step S1801, the CPU 1401 (the belt adjusting unit 1506) detects a detection shape 35 using the belt sensors 30a and 30b. As a result, an image near the detection shape 35 is acquired.

In step S1802, the CPU 1401 (the belt adjusting unit 1506) determines the center position of the two detection shapes 35 acquired by the belt sensors 30a and 30b.

In step S1803, the CPU 1401 (the belt adjusting unit 1506) determines the conveyance direction of the printing belt 25 using the center position of the two detection shapes 35. Here, the conveyance direction may be determined as the angle of a tilt with respect to a reference direction.

In step S1804, the CPU 1401 (the belt adjusting unit 1506) determines the drive amounts of the motors M2a and M2b according to the correction value θ1. For example, a mathematical function, a table, or a program module, where the correction value θ1 is an input and the drive amounts of the motors M2a and M2b are outputs, may be stored in the memory 1410. The CPU 1401 may use these to determine the motors M2a and M2b according to the correction value θ1.

In step S1805, the CPU 1401 (the belt adjusting unit 1506) drives the motors M2a and M2b according to the determined drive amounts. As a result, the conveyance direction of the printing belt 25 is shifted by the correction value θ1.

In step S1806, the CPU 1401 (the belt adjusting unit 1506) detects the detection shapes 35 using the belt sensors 30a and 30b. As a result, images near the detection shapes 35 of the printing belt 25 whose conveyance direction has been corrected are acquired.

In step S1807, the CPU 1401 (the belt adjusting unit 1506) determines the center position of the two detection shapes 35 acquired by the belt sensors 30a and 30b.

In step S1808, the CPU 1401 (the belt adjusting unit 1506) determines the conveyance direction of the printing belt 25 based on the center position of the two detection shapes 35.

In step S1809, the CPU 1401 (the belt adjusting unit 1506) determines whether or not there is a correction error, based on the correction value θ1 and a difference 40 between the conveyance direction acquired in step S1803 and the conveyance direction acquired in step S1808. When the correction error is unacceptably large, the CPU 1401 advances processing to step S1810. When the correction error is within an allowable range, the CPU 1401 ends the correction processing.

In step S1810, the CPU 1401 (the belt adjusting unit 1506) drives the motors M2a and M2b such that the correction error is reduced. Then, the CPU 1401 advances processing from step S1810 to step S1806. Processing from step S1806 to step S1810 is repeated until the correction error falls within the allowable range.

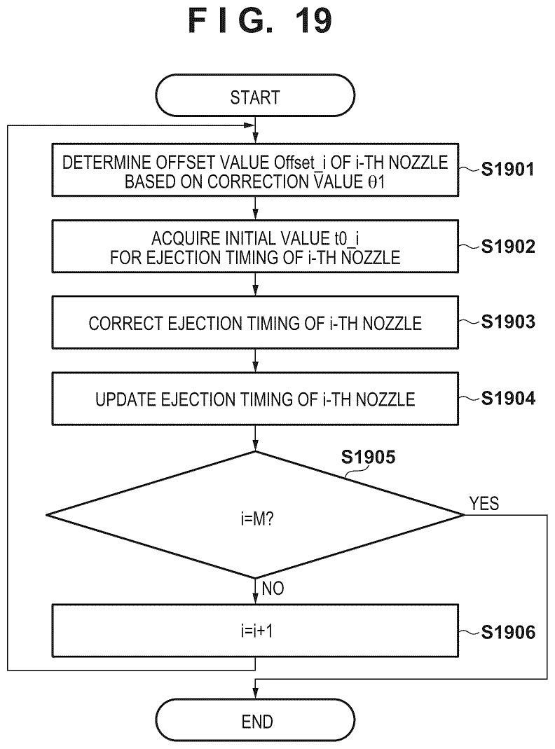

FIG. 19 shows a method for correcting the ejection timing of a nozzle according to the correction value θ1. Here, it is presumed that the recording head 10 includes M nozzles arranged side-by-side in the X-direction.

In step S1901, the CPU 1401 (the timing adjusting unit 1508) determines an offset value Offset_i for the ejection timing of the i-th nozzle based on the correction value θ1. The equation Eq. 6 may be used for this.

In step S1902, the CPU 1401 (the timing adjusting unit 1508) acquires an initial value t0_i for the ejection timing of the i-th nozzle. The initial value t0_i indicates the ejection timing of the i-th nozzle used when forming the test images for determining the correction value θ1.

In step S1903, the CPU 1401 (the timing adjusting unit 1508) corrects an ejection timing t_i of the i-th nozzle based on the offset value Offset_i and the initial value t0_i.

In step S1904, the CPU 1401 (the timing adjusting unit 1508) updates the ejection timing of the i-th nozzle stored in the memory 1410. Because the initial value t0_i is stored in the memory 1410, the initial value t0_i may be overwritten with t_i. The head control unit 1430 ejects ink according to the ejection timing (the initial value t0_i) for each nozzle stored in the memory 1410.

In step S1905, the CPU 1401 (the timing adjusting unit 1508) determines whether or not i is equal to M. That is, it is determined whether the ejection timings have been corrected for all from the first nozzle to the M-th nozzle. In a case where i is equal to M, the CPU 1401 ends correction processing. On the other hand, in a case where i is less than M, the CPU 1401 advances processing from step S1905 to step S1906.

In step S1906, the CPU 1401 (the timing adjusting unit 1508) adds 1 to i. Then, the CPU 1401 advances processing to step S1901.

According to this embodiment, the tilt between the printing belt 25 and the recording head 10 is corrected accurately. As a result, the squareness of an image is ensured. Alternatively, front/back misalignment is also reduced.

(15) Technical Concept Derived from Examples

### Aspect 1

The printing belt 25 is an example of a conveying unit (conveying body) for sucking a sheet S and conveying the sheet S in a conveyance direction. The inline scanner 1 is an example of a reading unit (reading device) for reading test images from the sheet S on which the test images have been formed by the recording heads 10, and the sheet S being conveyed by the conveying unit (conveying body). The memory 1410 is an example of a storage unit (memory) for storing, in advance, data (e.g., tilt amount θ2) regarding the tilt of alignment (misalignment) of the reading unit (reading device) with respect to the conveying unit (conveying body). The CPU 1401 and the correcting unit 1404 function as control unit (controllers) that control the shape of an image formed on a sheet, based on the result of reading test images and data regarding the tilt of alignment of the reading unit with respect to a predetermined conveyance direction of the conveying unit. As a result, the shape of the image in the image forming apparatus can be maintained at low cost and with high precision.

### Aspect 2

The CPU 1401 and the correcting unit 1404 are examples of a correcting unit for determining the amount of a relative tilt θ1 between the recording head 10 and the conveying unit (conveying body) based on the result of reading the test images and correcting the squareness of an image formed on the sheet S. The squareness is corrected based on, for example, the tilt amount θ2 of alignment of the reading unit (reading device) with respect to the conveying unit (conveying body) and the amount of the relative tilt θ1 between the recording head 10 and the conveying unit (conveying body). As a result, the shape of the image (in particular, squareness) in the image forming apparatus can be maintained at low cost and with high precision.

### Aspect 3

As shown in FIG. 13, a test chart (e.g., the calibration chart S0) for acquiring the tilt amount θ2 is conveyed by the conveying unit (conveying body). The CPU 1401 and the θ2 calculating unit 1603 are examples of a calculating unit (calculating device) for calculating the tilt amount θ2 based on the result of reading the test chart, and storing the tilt amount θ2 in the storage unit. As a result, alignment between the inline scanner 1 and the printing belt 25 is adjusted accurately.

### Aspect 4

The CPU 1401 and the θ2 calculating unit 1603 may calculate the tilt amount θ2 based on the tilt amount θ2c′ measured by a measuring device (e.g., a 2.5-dimensional measuring apparatus) and the tilt amount θ2c acquired from the result of the inline scanner 1 reading the test chart. As a result, alignment between the inline scanner 1 and the printing belt 25 is adjusted accurately.

### Aspect 5

As illustrated in FIG. 13, the test chart (e.g., the calibration chart S0) includes a sheet and test images formed to satisfy orthogonality with respect to the sheet. As a result, the amount of the tilt θ2 between the inline scanner 1 and the printing belt 25 will be acquired accurately.

### Aspect 6

The CPU 1401 and the correcting unit 1404 may include adjusting unit (e.g., the belt adjusting unit 1506, motors M2a and M2b) for adjusting the conveyance direction of the conveying unit (conveying body) based on the tilt amount θ2 and the tilt amount θ1. As a result, alignment between the printing belt 25 and the recording head 10 is adjusted accurately, and the squareness of an image is maintained.

### Aspect 7

The printing belt 25 is an example of an endless printing belt. The endless printing belt may be configured to rotate while being stretched over at least two or more rollers (e.g., the stretch rollers 21 and 24). The sheet S is carried and conveyed on the outer peripheral surface (e.g., the image forming surface 26) of the endless printing belt between the first roller (e.g., the stretch roller 21) and the second roller (e.g., the stretch roller 24) out of two or more rollers. The CPU 1401 and the correcting unit 1404 move at least one of the first roller and the second roller in the rotation axis direction, using the adjusting unit (e.g., the belt adjusting unit 1506, the motors M2a and M2b). As a result, the squareness of an image may be corrected.

### Aspect 8

The belt sensors 30a and 30b are examples of a detecting unit (sensor) for detecting at least one end portion in the width direction (e.g., the X-direction) of the endless belt. The belt adjusting unit 1506 may determine, based on the tilt amount θ2 and the tilt amount θ1, a position where one end portion needs to pass, and adjust the conveyance direction of the conveying unit such that the position of one end portion detected by the detecting unit matches the position where one end portion needs to pass. When the conveyance direction is detected by a sensor, the conveyance direction will be accurately adjusted in this manner.

### Aspect 9

The CPU 1401 and the correcting unit 1404 may include adjusting unit (e.g., the head adjusting unit 1507, the motor M3) for adjusting the mounting angle of the recording head 10 based on the tilt amount θ2 and the tilt amount θ1. As a result, alignment between the printing belt 25 and the recording head 10 is adjusted accurately, and the squareness of an image is maintained. At least one of the printing belt 25 and the recording head 10 needs only be moved in this manner.

### Aspect 10

As shown in FIG. 4, the recording head 10 includes a plurality of nozzles that are arranged along the longitudinal direction of the recording head 10 and each eject ink. The CPU 1401 and the correcting unit 1404 include adjusting unit (e.g., the timing adjusting unit 1508) for adjusting the ejection timings of the plurality of nozzles based on the tilt amount θ2 and the tilt amount θ1.

### Aspect 11

The CPU 1401 and the correcting unit 1404 correct image data that is the source of an image based on the tilt amount θ2 and the tilt amount θ1, and thus transform the image in advance such that the image has an inverse characteristic of the squareness characteristic of the recording head 10. The recording head 10 forms a pre-transformed image. The squareness of an image formed on the sheet S may be maintained by transforming the original image.

### Aspect 12

As illustrated in FIG. 8, the test image may include four reference images (e.g., cross marks) corresponding to the four corners of the sheet S. The CPU 1401 and the correcting unit 1404 determine a tilt (e.g., θ1a) between a leading end side of the sheet in the conveyance direction of the sheet S and a straight line connecting a first reference image and a second reference image out of the four reference images included in the reading result. Further, the CPU 1401 and the correcting unit 1404 determine a tilt (θ1b) between a rear end side of the sheet in the conveyance direction of the sheet S and a straight line connecting a third reference image and a fourth reference image. Furthermore, the average thereof may also be determined. The CPU 1401 and the correcting unit 1404 may determine the tilt amount θ1 by subtracting the tilt amount θ2 from the average, and correct the squareness of the image according to the tilt amount θ1. The squareness of an image can be more accurately corrected using a statistical method in this manner.

### Aspect 13

The test image may include two reference images corresponding to two corners of the four corners of the sheet S that are close to the leading end side of the sheet S in the conveyance direction of the sheet S. The CPU 1401 and the correcting unit 1404 may determine the tilt amount θ1 by subtracting the tilt amount θ2 from the tilt between the leading end side of the sheet S and a straight line connecting the two reference images included in the reading result.

### Aspect 14

The test image may include two reference images corresponding to two corners of the four corners of the sheet S that are close to the rear end side of the sheet S in the conveyance direction of the sheet S. The CPU 1401 and the correcting unit 1404 may determine the tilt amount θ1 by subtracting the tilt amount θ2 from the tilt between the rear end side of the sheet S and a straight line connecting the two reference images.

### Aspect 15

Test images may be respectively formed on a plurality of sheets S. The inline scanner 1 may acquire a plurality of reading results from the test images respectively formed on the plurality of the sheets S conveyed. The CPU 1401 and the correcting unit 1404 may determine the average of the tilt amounts θ1 from the plurality of reading results, and correct the squareness of an image based on the tilt amount θ2 and the average of the tilt amounts θ1. As a result, the squareness of an image is further accurately corrected.

### Aspect 16

The CPU 1401 and the correcting unit 1404 may control the shape of an image formed on a sheet based on coordinates of the four reference images included in the reading result and data regarding the alignment tilt. For example, the CPU 1401 and the correcting unit 1404 may calculate a correction value for correcting squareness by determining coordinates of the four cross marks from the result of reading the test image, and inputting the coordinates and data regarding the alignment tilt into a calculation equation. The calculation equation is determined in advance and stored in the memory 1410.

### Aspect 17

The recording unit may be an image forming unit (e.g., a photosensitive drum) for forming an image on a sheet using toner.

### Aspect 18

The reversing unit 4200 is an example of a reversing unit (reverse roller) for reversing the sheet S on which an image has been formed on the first side. The double-sided conveyance path 5300 is an example of a conveyance path along which the sheet S reversed by the reversing unit (reverse roller) is conveyed by the conveying unit (conveying body). The recording head 10 forms an image on the second side of the sheet S on which an image has been formed on the first side. Front/back misalignment is also reduced by correcting the squareness of an image.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-093309, filed Jun. 6, 2023 which is hereby incorporated by reference herein in its entirety.

What is claimed is:

1. An image forming apparatus comprising:
a belt member configured to convey a sheet while carrying the sheet;
an image forming unit provided with a plurality of nozzles for ejecting ink and configured to form an image on the sheet carried by the belt member using the ink ejected from the plurality of nozzles;
a reader configured to read the sheet on which the image is formed by the image forming unit;
a memory on which data regarding a tilt of the reader is stored; and
a controller configured to control the image forming unit to form a test image on a sheet, and determine a misalignment of a first direction in which the plurality of nozzles are arranged with respect to a second direction based on the data stored in the memory and a result of reading the sheet read by the reader and on which the test image is formed.

2. The image forming apparatus according to claim 1,
wherein the controller is further configured to adjust a shape of an image to be formed on a sheet by the image forming unit, based on the misalignment of the first direction with respect to the second direction.

3. The image forming apparatus according to claim 1,
wherein the second direction is a conveyance direction in which the belt member conveys the sheet.

4. The image forming apparatus according to claim 1,
wherein the tilt of the reader is a tilt of the reader with respect to a conveyance direction in which the belt member conveys the sheet.

5. The image forming apparatus according to claim 1,
wherein the controller is further configured to adjust a conveyance direction in which the belt member conveys the sheet, based on the misalignment of the first direction with respect to the second direction.

6. The image forming apparatus according to claim 1,
wherein the controller is further configured to adjust an ejection timing at which the ink is ejected from the plurality of nozzles, based on the misalignment of the first direction with respect to the second direction.

7. The image forming apparatus according to claim 1,
wherein the controller is further configured to adjust a mounting angle of the image forming apparatus, based on the misalignment of the first direction with respect to the second direction.

8. The image forming apparatus according to claim 1,
wherein the controller is further configured to transform an image to be formed by the image forming apparatus, based on the misalignment of the first direction with respect to the second direction.

9. The image forming apparatus according to claim 1,
wherein the controller is further configured to control the reader to read a calibration chart for detecting a tilt of the reader, and generate the data based on a result obtained by the reader reading the calibration chart.

10. The image forming apparatus according to claim 1,
wherein the controller is further configured to determine a tilt of the test image on the sheet based on the result of reading the sheet on which the test image is formed, and determine the misalignment of the first direction with respect to the second direction based on the data stored in the memory and the tilt of the test image on the sheet.

11. The image forming apparatus according to claim 9,
wherein the data is an amount of the tilt of the reader with respect to a conveyance direction in which the belt member conveys the sheet, and
the controller is further configured to determine the misalignment of the first direction with respect to the second direction by subtracting the tilt amount from the tilt of the test image on the sheet.

12. The image forming apparatus according to claim 1,
wherein the data is an amount of the tilt of the reader with respect to a conveyance direction in which the belt member conveys the sheet,
the test image includes reference images formed in four corner regions of the sheet, and
the controller is further configured to:
determine a first tilt between a leading end side of the sheet in the conveyance direction in which the belt member conveys the sheet and a straight line connecting a first reference image included in the reference images and a second reference image included in the reference images, based on the result of reading the sheet on which the test image read by the reader is formed;
determine a second tilt between a rear end side of the sheet in the conveyance direction and a straight line connecting a third reference image included in the reference images and a fourth reference image included in the reference images, based on the result of reading the sheet on which the test image read by the reader is formed;
determine an average of the first tilt and the second tilt; and
determine the misalignment of the first direction with respect to the second direction by subtracting the tilt amount of the reader from the average.

13. The image forming apparatus according to claim 1,
wherein the data is an amount of the tilt of the reader with respect to a conveyance direction in which the belt member conveys the sheet,
the test image includes reference images formed on a leading end side of the sheet in the conveyance direction, and
the controller is further configured to:
determine a tilt between a leading end side of the sheet in the conveyance direction and a straight line connecting a first reference image included in the reference images and a second reference image included in the reference images, based on the result of reading the sheet on which the test image read by the reader is formed; and
determine the misalignment of the first direction with respect to the second direction by subtracting the tilt amount of the reader from the tilt between the leading end side and the straight line.

14. The image forming apparatus according to claim 1,
wherein the data is an amount of the tilt of the reader with respect to a conveyance direction in which the belt member conveys the sheet,
the test image includes reference images formed on a rear end side of the sheet in the conveyance direction, and
the controller is further configured to:
determine a tilt between a rear end side of the sheet in the conveyance direction and a straight line connecting a first reference image included in the reference images and a second reference image included in the reference images, based on the result of reading the sheet on which the test image read by the reader is formed; and
determine the misalignment of the first direction with respect to the second direction by subtracting the tilt amount of the reader from the tilt between the rear end side and the straight line.

15. The image forming apparatus according to claim 1,
wherein the image forming unit repeatedly forms the test image on a plurality of sheets, and
the controller is further configured to determine the misalignment of the first direction with respect to the second direction based on the data stored in the memory and results of reading the plurality of sheets read by the reader and on which the test images are formed.
